(19) United States
(12) Patent Application Publication
(10) Pub. No.: US 2024/0300231 A1
(43) Pub. Date: Sep. 12, 2024

(54) SHEET ASSEMBLY FOR FORMING ONE OR MORE CARDS

(71) Applicant: Illinois Tool Works Inc., Glenview, IL (US)

(72) Inventors: Suwit John Sangkaratana, Crown Point, IN (US); Robert Michael Korson, Traverse City, MI (US)

(73) Assignee: Illinois Tool Works Inc., Glenview, IL (US)

(21) Appl. No.: 18/264,011

(22) PCT Filed: Feb. 10, 2022
(86) PCT No.: PCT/US2022/070599

§ 371 Date: Aug. 2, 2023

Related U.S. Application Data
(60) Provisional application No. 63/147,898, filed on Feb. 10, 2021.

(51) Int. Cl. B32B 29/06

(52) U.S. Cl. CPC B32B 29/06; B32B 2260/028; B32B 2260/046; B32B 2264/10; B32B 2307/206; B32B 2307/75

(57) ABSTRACT

A sheet assembly can be cut into one or more cards. The sheet assembly includes an upper layer configured to receive a first printing of first indicia for the one or more cards. The sheet assembly may further include a core coupled with the upper layer and a lower layer configured to receive a second printing of second indicia for the one or more cards. The lower layer is coupled with the core with the core disposed between the upper sheet and the lower sheet. One or more of the upper layer, the core, or the lower layer is formed from paper impregnated with a resin that includes a biobased resin.

### CROSS REFERENCE TO RELATED APPLICATION

This application is a national phase entry of and claims priority to International Patent Application No. PCT/US2022/070599 (filed 10 Feb. 2022), which claims priority to U.S. Application No. 63/147,898 (filed 10 Feb. 2021), the entire contents of which are incorporated herein by reference.

### BACKGROUND

### Technical Field

The subject matter described herein relates to multi-layer sheet assemblies that can be cut into smaller cards, such as identification cards, financial transaction cards (e.g., credit cards, debit cards, gift cards, or the like), or other types of cards.

### Discussion of Art

Cards are used for a variety of purposes, such as identification or security, financial transactions, etc. With the trend toward increased environmental concerns and “green” products, some manufacturers have turned to making biodegradable cards. These cards may be formed from paper layers held together by biodegradable polymers. But these known biodegradable cards are not durable and may not withstand repeated usage, humid environments, or the like. For example, some of these cards suffer from delamination that renders the card unusable. Some higher-end financial transaction cards are made from or include metals to provide a heavier card, which can be desirable by customers. But inclusion of these types of materials can make it harder or more costly to recycle the cards.

### BRIEF DESCRIPTION

In one embodiment, a sheet assembly is provided that can be cut into one or more cards. The sheet assembly includes an upper layer configured to receive a first printing of first indicia for the one or more cards. The sheet assembly may also include a core coupled with the upper layer and a lower layer configured to receive a second printing of second indicia for the one or more cards. The lower layer may be coupled with the core with the core disposed between the upper sheet and the lower sheet. One or more of the upper layer, the core, or the lower layer may be formed from paper impregnated with a resin that includes a biobased resin.

In one embodiment, a method for producing a sheet assembly may include forming a core and coupling an upper layer to the core, the upper layer configured to receive a first printing of first indicia for one or more cards. The method may include coupling a lower layer to the core to form a sheet assembly of the upper layer, the core, and the lower layer. The lower layer may be coupled with the core with the core disposed between the upper layer and the lower layer. The lower layer may be configured to receive a second printing of second indicia for the one or more cards. The sheet assembly may be configured to be cut into one or more cards. One or more of the upper layer, the core, or the lower layer may be formed from paper impregnated with a resin that includes a biobased.

### BRIEF DESCRIPTION OF THE DRAWINGS

The inventive subject matter may be understood from reading the following description of non-limiting embodiments, with reference to the attached drawings, wherein below:

FIG. 1 illustrates a perspective view of one embodiment of a multi-layer sheet assembly;

FIG. 2 illustrates a cross-sectional view of a card shown in FIG. 1 along line 2-2 in FIG. 1 according to one embodiment;

FIG. 3 illustrates a cross-sectional view of a card shown in FIG. 1 along line 2-2 in FIG. 1 according to one embodiment;

FIG. 4 illustrates a cross-sectional view of a card shown in FIG. 1 along line 2-2 in FIG. 1 according to one embodiment;

FIG. 5 illustrates a cross-sectional view of a card shown in FIG. 1 along line 2-2 in FIG. 1 according to one embodiment;

FIG. 6 illustrates an exploded view of a card according to one embodiment; and

FIG. 7 illustrates a flowchart of a method for forming a sheet assembly that can be cut into smaller cards according to one embodiment.

### DETAILED DESCRIPTION

The inventive subject matter described herein provides multi-layer sheet assemblies from which several cards can be cut. The cards can be shaped for use as identification cards, security cards, financial transaction cards, etc. The sheet assemblies can be formed from materials that include resin-impregnated paper. The resin may be a petroleum-based resin or a biobased resin. A biobased resin may include resins formed of renewable or biological resources such as plants. A biobased resin may include resins that are not petroleum-based resins. The resins may be thermoplastic or thermoset.

The cards may include high density particles to enhance the properties of the card and provide the card with a weight and feel of a metal or heavy impact card. The high-density particles may be provided to make the cards electrically non-conductive so that the cards are not subject to electrostatic discharge. The cards may be manufactured using current equipment used to make plastic cards. The cards may be more durable than current plastic cards and may be usable for up to five or more years. The cards may be, for example, financial transaction cards, identification cards, key cards, access cards, or security cards.

The sheet assembly may also be used to form other products. For example, the sheet assembly may be used to form decorative laminates for countertops, tabletops, furniture surfaces, and flooring.

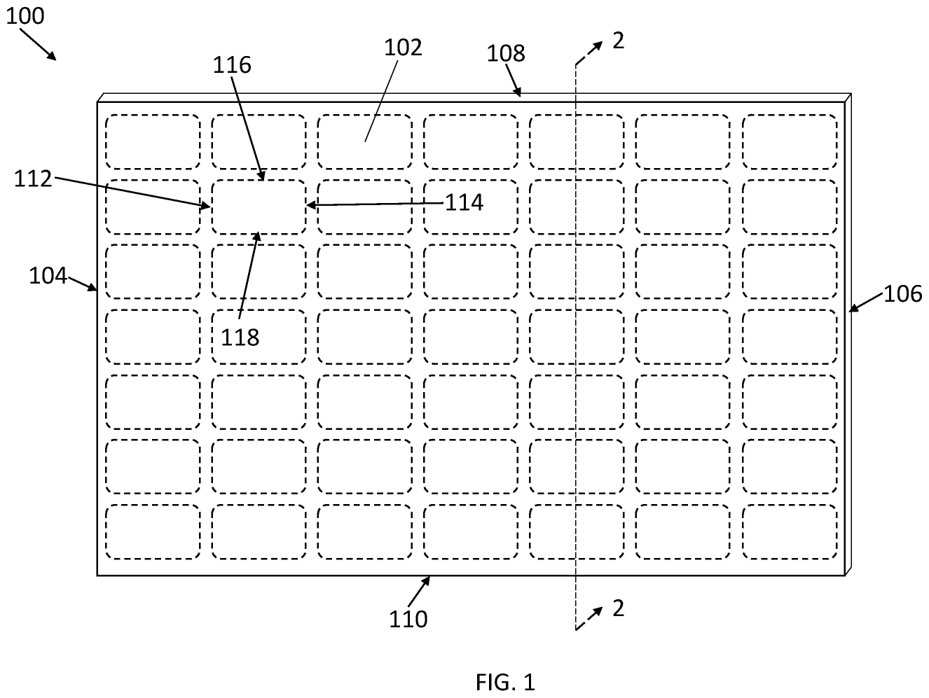

FIG. 1 illustrates a perspective view of one embodiment of a multi-layer sheet assembly 100. The sheet assembly 100 can be large enough to cut several cards 102 from the sheet assembly. These cards 102 may be identification cards (e.g., drivers' licenses, work identification cards, etc.), financial transaction cards (e.g., credit cards, debit cards, gift cards, etc.), or the like. In one embodiment, each of the cards 102 has a shape and size defined by the ISO/IEC 7810 ID-1 standard. Alternatively, the cards 102 may have a different shape and/or size. The sheet assembly 100 may be large enough to cut several (e.g., sixty-three or another number) of the cards 102 from the sheet assembly 100. For example, the sheet assembly 100 may have a surface area on each side of the sheet assembly 100 that is at least 2,911 square centimeters.

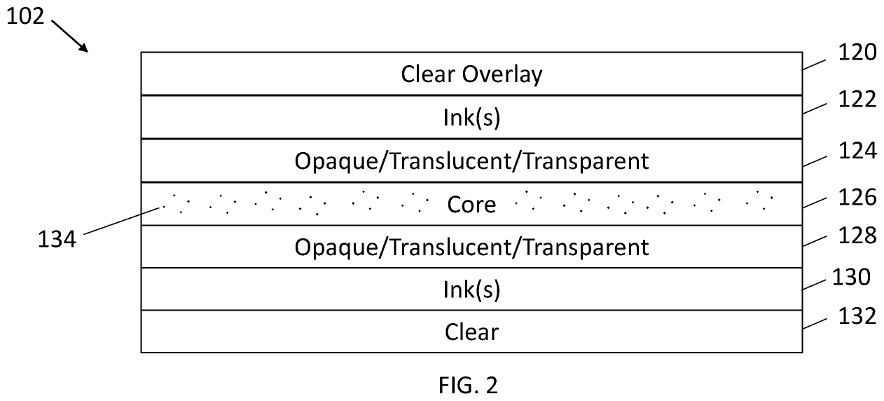

FIG. 2 illustrates a cross-sectional view of the card shown in FIG. 1 along line 2-2 in FIG. 1. The card includes an upper clear overlay layer 120 and a lower clear overlay layer 132. The upper and lower clear overlay layers may be formed of a polymer. In another embodiment, the upper and lower clear overlay layers may be formed of paper impregnated with a resin. The resin-impregnated paper may be saturated with the resin. The resin-impregnated paper may have an inter-penetrating network of paper fibers and polymers of the resin. The paper-impregnated resin may have the resin dispersed throughout or embedded within the paper. The resin-impregnated paper may have the resin blended with the paper. The resin may be uniformly or homogenously provided in the resin-impregnated paper.

The resin may include a biobased resin. A biobased resin may be a resin that is formed of a biological resource(s), for example plants. A biobased resin may be a resin that is not petroleum-based. The resin may also include petroleum-based resin(s). For example, the resin-impregnated paper may be impregnated with a resin that is 40% biobased resin and the remainder petroleum-based resin. According to other examples, the resin may include up to 50%, up to 60%, up to 70%, up to 80%, up to 90%, or up to 100% biobased resin, with a remainder petroleum-based resin. According to another example, the resin-impregnated paper may include a resin that is 40%-70% biobased resin.

Biobased resins that may be in the resin-impregnated paper may include biobased polymers formed with cellulosics, lignocellulosics, natural fibers, starches, polysaccharides, fats and oils, protein, and/or alginates. Examples of natural fibers may include kenaf, sisal, jute, hemp, and flax. Examples of starches may include corn, potato, or tapioca starch. Examples of polysaccharides may include pectin, chitin, levan, or pullalan. Examples of fats and oils may include soybeans, lesquerella, and rapeseed. Examples of proteins may include casein. zein, or soy protein.

Biobased polymers that may be in the resin-impregnated paper may include polylactic acid (PLA), polyhydroxyalkanoates (PHA), polybutylene adipate terephthalate (PBAT), polybutylene succinates (PBS), polyethylene (PE); polypropylene (PP), polyethylene terephthalate (PET), polyurethanes (PUR), ethylene propylene diene monomer (EPDM), polyvinylchloride (PVC), polymethyl methacrylate (PMMA), polyethylene furanoate (PEF), polytrimethylene furandicarboxylate (PTF), polytrimethylene terephthalate (PTT), styrene-butadiene rubber (SBR), polybutylene terephthalate (PBT), acrylonitrile butadiene styrene (ABS), and polyamides (PA), aliphatic polycarbonates (APC), and cellulose acetate (CA).

Biobased films that may be used in the sheet assembly may be formed of biobased polymers discussed above. For example, a biobased film that may be used in the sheet assembly may be a biobased polycarbonate film formed of a biobased polycarbonate such as DURABIO™ from Mitsubishi Chemical or MAKROFOL® EC from Covestro Deutschland AG. For example, a biobased film that may be used in the sheet assembly may be a cellulose-based polymer such as TREVA™ or a biobased copolyester such as TRITAN™ from Eastman Chemical Company.

The paper may be a phenolic paper. The paper may be impregnated up to about 50% with the resin. The paper may be impregnated with less than about 50% of resin including petroleum-based resin. Other resins that may be used to impregnate the paper include melamine, formaldehyde, and phenolic resins.

The card may further include an upper print layer 122 and a lower print layer 130. The upper print layer 122 and the lower print layer 130 may be formed from a material that is capable of being printed upon by inks to form indicia on a visible surface (e.g., top or front surface) of the upper print layer 122 and a visible surface (e.g., bottom or back surface) of the lower print layer 130 of the card(s) 102. The indicia can include identifying information (e.g., a person's name, a company name, an account number, a photograph, an image, etc.) or other information. The upper print layer and the lower print layer may be formed of polyethylene terephthalate (PET). The upper print layer and the lower print layer may be formed of biobased polycarbonate film. The upper print layer 122 and the lower print layer 130 may be formed of pre-impregnated print base paper.

The upper and lower print layer may also can include one or more optical features of the card. For example, one or more metal sheets bodies, or the like, can be included in and/or added to one or more of the upper or lower print layers to form a reflective feature, a diffractive feature, security and/or an opaque feature of the card.

The card may also include an upper resin-impregnated printable paper layer 124 and a lower resin-impregnated printable layer 128. The upper and lower biobased resin impregnated printable paper layers may be opaque, translucent, or transparent. The resin may include a biobased resin. The rein may include a petroleum-based resin. For example, the resin may be a resin that is 40%-70% biobased resin with the remainder of the resin a petroleum-based resin.

The card may also include a core 126. The core may be formed of a resin-impregnated paper. The resin may include a biobased resin. The resin may also include a petroleum-based resin. For example, the resin may be a resin that is 40%-70% biobased resin with the remainder of the resin a petroleum-based resin. The core may be formed as a split core by providing the core as multiple thin layers or sheets. The paper and/or the impregnated resin of the core may include high-density particles 134 to increase the weight of the card, which can be desirable for higher end or luxury transactional cards, without having to include metal layers within the sheet assembly 100 or the cards 102. This can prevent the sheet assembly 100 and each of the cards 102 from forming, having, or including a conductive layer that conducts ESD or other electric current through the sheet assembly 100 or the card(s) 102. Optionally, other layers of the card may have high density particles provided in one or more of the paper or resin. Optionally, none of the layers of the card may have high density particles.

The high-density particles may be inorganic particles. The inorganic particles 208 may include one or more of bismuth vanadate, one or more metal oxide pigments, or one or more conductive particles (e.g., copper particles, bronze particles, etc.). While the inorganic particles may include metal, metal oxides, or other conductive particles, the inorganic particles can be separated from each other by the paper and/or the biobased resin such that no conductive pathway exists through the sheet assembly 100 and/or cards 102 from one edge or any other edge via the inorganic particles.

The sheet assembly 100 may continuously extend from a first edge 104 to an opposite second edge 106 and may continuously extend from a third edge 108 (that intersects both the first edge 104 and the second edge 106) to an opposite fourth edge 110 (that intersects both the first edge 104 and the second edge 106). Each of the cards 102 similarly may continuously extend from a first edge 112 to an opposite second edge 114 and may continuously extend from a third edge 116 (that intersects both the first edge 112 and the second edge 114) to an opposite fourth edge 118 (that intersects both the first edge 112 and the second edge 114). The absence of a conductive layer, sheet, core, or body in the sheet assembly 100 and in each of the cards 102 can prevent the sheet assembly 100 from conducting ESD or other electric current from one sheet edge 104, 106, 108, 110 to any other sheet edge 104, 106, 108, 110 and can prevent each of the cards 102 from conducting ESD or other electric current from one card edge 112, 114, 116, 118 to any other card edge 112, 114, 116, 118.

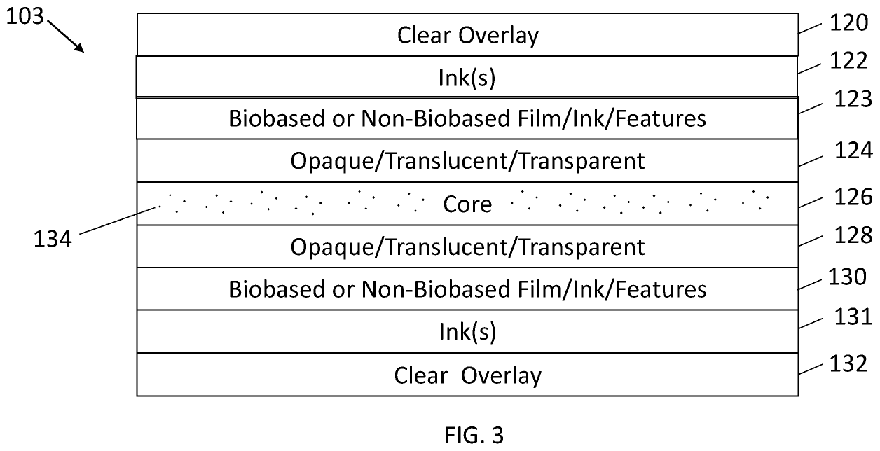

Referring to FIG. 3, a card 103 according to one embodiment may include an upper clear overlay layer 120, a lower clear overlay layer 132, an upper print layer 122, a lower print layer 130, an upper resin-impregnated printable paper layer 124, a lower resin-impregnated printable paper layer 128, and a core 126, as described above with respect to FIG. 2. The card 103 may also include an upper biobased film 123 between the upper resin-impregnated printable paper layer and the upper print layer 122. The upper film 123 may be a non-biobased film. The upper biobased film may be a biobased polycarbonate. The card 103 may also include a lower biobased film 130 between the lower resin-impregnated printable paper layer 128 and the lower print layer 131. The lower biobased film may be a biobased polycarbonate. The lower film 130 may be a non-biobased film.

One or more of the upper and lower biobased films may include metallized, holographic, diffractive, refractive, color shifting, and/or security features.

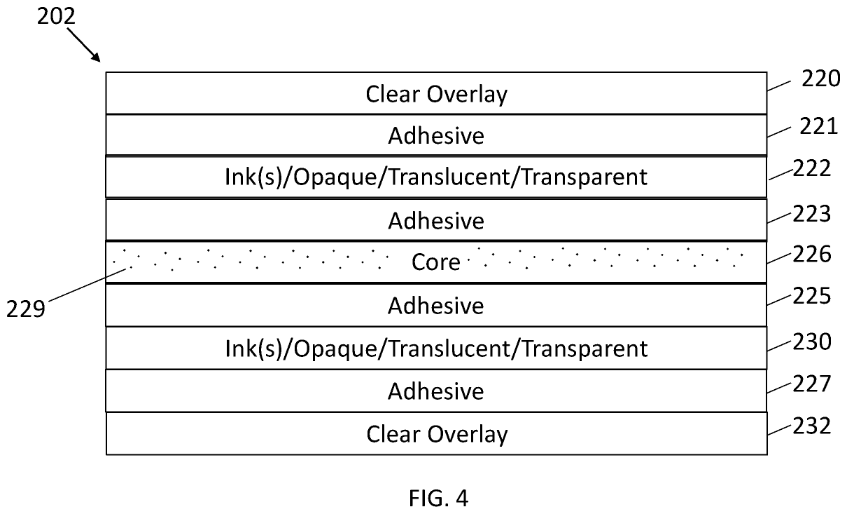

Referring to FIG. 4, a card 202 according to one embodiment may include an upper clear overlay layer 220 and a lower clear overlay layer 232. The upper and lower clear overlay layers may be formed of a polymer. In another embodiment the upper and lower clear overlay layers may be formed of paper impregnated with a resin. The resin may include a biobased resin. The resin may also include a petroleum-based resin. For example, the resin may be a resin that is 40%-70% biobased resin with the remainder of the resin a petroleum-based resin. The resin may be a thermoset resin. The resin may be a thermoplastic resin. The paper may be a phenolic paper. The paper may be impregnated up to about 50% with biobased resin. The paper may be impregnated with less than about 50% of resin including petroleum-based resin. Other resins that may be used to impregnate the paper include melamine, formaldehyde, and phenolic resins.

The card may further include an upper print layer 222 and a lower print layer 230. The upper print layer and the lower print layer may be formed from a material that is capable of being printed upon by inks to form indicia on a visible surface (e.g., top or front surface) of the upper print layer and a visible surface (e.g., bottom or back surface) of the lower print layer of the card(s). The indicia can include identifying information (e.g., a person's name, a company name, an account number, a photograph, an image, etc.) or other information. The upper print layer and the lower print layer may be formed of PET. The upper print layer and the lower print layer may be formed of biobased polycarbonate film. The upper print layer and the lower print layer may be formed of pre-impregnated print base paper. The upper print layer and the lower print layer may be opaque, translucent, or transparent.

The upper print layer and the lower print layer may be attached to the upper clear overlay layer and the lower clear overlay layer, respectively, by an upper adhesive layer 221 and a lower adhesive layer 227. Optionally, the card may not include the upper and lower adhesive layers and the clear overlay layers may be attached to the print layers by applying heat and pressure to the layers of the card during a manufacturing process.

The card may further include a core 226. The core may be formed of a resin-impregnated paper. The resin may include a biobased resin. The resin may also include a petroleum-based resin. For example, the resin may be a resin that is 40%-70% biobased resin with the remainder of the resin a petroleum-based resin. The core may be formed as a split core by providing the core as multiple thin layers or sheets. The paper and/or the impregnated resin of the core may include high-density particles 229 to increase the weight of the card, which can be desirable for higher end or luxury transactional cards, without having to include metal layers within the sheet assembly or the cards. This can prevent the sheet assembly and each of the cards from forming, having, or including a conductive layer that conducts ESD or other electric current through the sheet assembly or the card(s). Optionally, other layers of the card may have high density particles provided in one or more of the paper or resin. Optionally, none of the layers of the card may have high density particles.

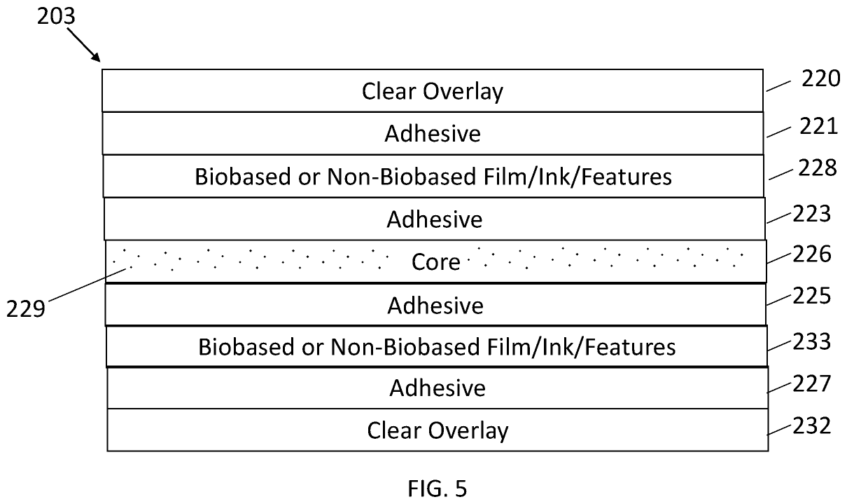

Referring to FIG. 5, a card 203 according to one embodiment may include an upper clear overlay layer 220 and a lower clear overlay layer 232. The upper and lower clear overlay layers may be formed of a polymer. In another embodiment the upper and lower clear overlay layers may be formed of paper impregnated with a resin. The resin may include a biobased resin. The resin may also include a petroleum-based resin. For example, the resin may be a resin that is 40%-70% biobased resin with the remainder of the resin a petroleum-based resin. The resin may be a thermoset resin. The resin may be a thermoplastic resin. The paper may be a phenolic paper. The paper may be impregnated up to about 50% with biobased resin. The paper may be impregnated with less than about 50% of resin including petroleum-based resin. Other resins that may be used to impregnate the paper include melamine, formaldehyde, and phenolic resins. The card may further include an upper film 228 that may be a biobased film. The upper biobased film may be attached to the upper clear overlay layer by an adhesive 221. The upper biobased film may be a biobased polycarbonate. The upper biobased film may also include metallized, holographic, diffractive, refractive, color shifting, and/or security features. The upper film may be a non-biobased film.

The card may further include a lower film 233 that may be a biobased film. The lower biobased film may be attached to the lower clear overlay layer by an adhesive layer 227. The lower biobased film may be a biobased polycarbonate. The lower biobased film may also include metallized, holographic, diffractive, refractive, color shifting, and/or security features.

The card may further include ink forming a print layer on one or more of the upper film 228 or the lower film 233. The upper print layer and the lower print layer may be formed from a material that is capable of being printed upon by inks to form indicia on a visible surface (e.g., top or front surface) of the upper print layer and a visible surface (e.g., bottom or back surface) of the lower print layer of the card(s). The indicia can include identifying information (e.g., a person's name, a company name, an account number, a photograph, an image, etc.) or other information.

The card may further include a core 226. The core may be formed of a resin-impregnated paper. The resin may include a biobased resin. The resin may also include a petroleum-based resin. For example, the resin may be a resin that is 40%-70% biobased resin with the remainder of the resin a petroleum-based resin. The core may be formed as a split core by providing the core as multiple thin layers or sheets. The paper and/or the impregnated resin of the core may include high-density particles 229 to increase the weight of the card, which can be desirable for higher end or luxury transactional cards, without having to include metal layers within the sheet assembly or the cards. This can prevent the sheet assembly and each of the cards from forming, having, or including a conductive layer that conducts ESD or other electric current through the sheet assembly or the card(s). Optionally, other layers of the card may have high density particles provided in one or more of the paper or resin. Optionally, none of the layers of the card may have high density particles. The upper film 228 may be attached to the core 226 by an adhesive layer 223 and the lower film 233 may be attached to the core 226 by an adhesive layer 225.

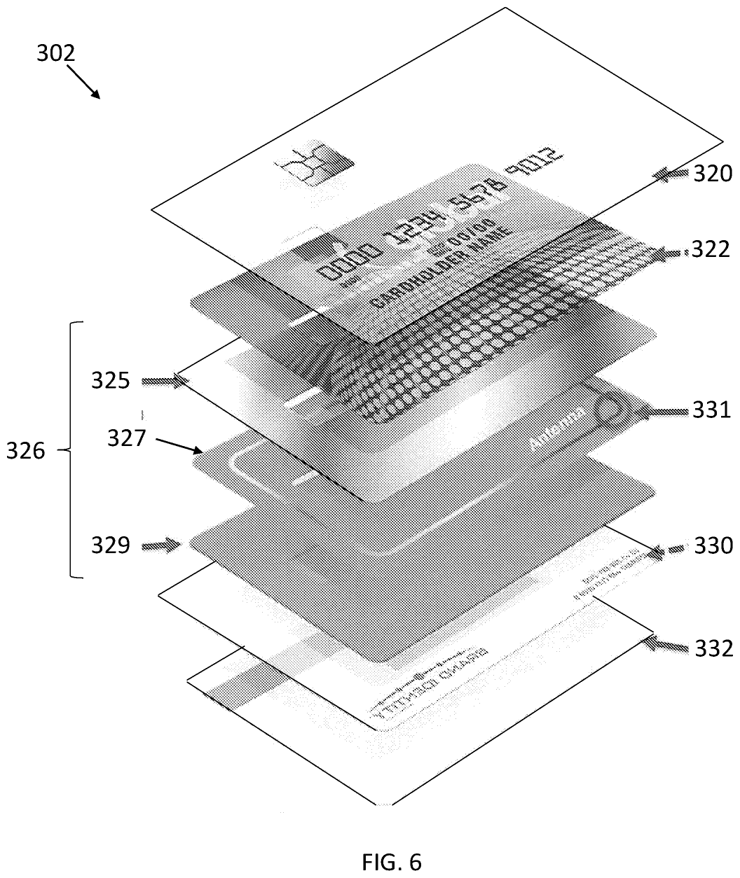

Referring to FIG. 6, a card 302 according to one embodiment may include an upper clear overlay layer 320 and a lower clear overlay layer 332. The upper and lower clear overlay layers may be formed of paper impregnated with a resin. The resin may a biobased resin. The resin may also include petroleum-based resin. For example, the resin may be a resin that is 40%-70% biobased resin with the remainder of the resin a petroleum-based resin. The resin may be a thermoset resin. The resin may be a thermoplastic resin. The paper may be a phenolic paper. The paper may be impregnated up to about 50% with a biobased resin. The paper may be impregnated with less than about 50% of resin including a petroleum-based resin. Other resins that may be used to impregnate the paper include melamine, formaldehyde, and phenolic resins.

The card may further include an upper print layer 322 and a lower print layer 330. The upper print layer and the lower print layer may be formed from a material that is capable of being printed upon by inks to form indicia on a visible surface (e.g., top or front surface) of the upper print layer and a visible surface (e.g. bottom or back surface) of the lower print layer of the card(s). The indicia can include identifying information (e.g., a person's name, a company name, an account number, a photograph, an image, etc.) or other information. The upper print layer and the lower print layer may be formed of PET. The upper print layer and the lower print layer may be formed of biobased polycarbonate film. The upper print layer and the lower print layer may be formed of pre-impregnated print base paper.

The upper print layer and the lower print layer may be attached to the upper clear overlay layer and the lower clear overlay layer. In one embodiment, the upper clear overlay layer and the lower clear overlay layer may be attached to the upper and lower print layers by applying heat and pressure to the layers of the card during a manufacturing process.

The card may further include a core 326. The core may include an upper core layer 325, a middle core layer 327, and a lower core layer 329. The core may include one or more optical features of the card. For example, one or more metal sheets bodies, or the like, can be included in and/or added to the upper core layer, the middle core layer, and/or the lower core layer to form a reflective feature, a diffractive feature, and/or a holographic feature of the card. As described above, the core layers may be formed of a resin-impregnated paper. The paper and/or the impregnated resin of one or more of the core layers may include high-density particles to increase the weight of the card, which can be desirable for higher end or luxury transactional cards, without having to include metal layers within the sheet assembly or the cards. This can prevent the sheet assembly and each of the cards from forming, having, or including a conductive layer that conducts ESD or other electric current through the sheet assembly or the card(s). Optionally, other layers of the card may have high density particles provided in one or more of the paper or resin. Optionally, none of the layers of the card may have high density particles.

The core may include one or more inlays 331, such as an electronic circuit or antenna, in one or more of the core layers, between two of the core layers, and/or between one or more core layers and the print layers. In the illustrated embodiment, the inlay is disposed within the middle core layer. The inlay can represent a radio frequency identification (RFID) antenna that can be used to receive and/or communicate electromagnetic signals via electromagnetic waves responsive to being interrogated by an RFID reader. For example, the circuit inlay can be used for contactless or wireless transactions involving the card.

As described below, one or more additional layers, sheets, or components may be included in the sheet assembly and/or placed on the sheets prior to or after the cards are cut from the sheet assembly to complete manufacture of the cards. The core of the sheet assembly and the cards may provide for increased weight of the cards (which can be desirable for higher end or luxury transactional cards) without having to include metal layers within the sheet assembly or the cards. This can prevent the sheet assembly and each of the cards from forming, having, or including a conductive layer that conducts ESD or other electric current through the sheet assembly or the card(s).

After cutting the card from the sheet assembly, one or more inks may be printed, transferred, or otherwise deposited onto the upper and/or lower print layer. These inks can form text, numbers, images, or the like, for use in identifying a holder of the card, identifying a financial institution, identifying an account, or the like. Optionally, the inks can form graphics or the like. While the inks may be shown in the drawings as a continuous layer extending over the print layers, alternatively the inks may only cover part, but not all, of the upper and/or lower print layer.

The upper and/or lower clear overlay layer can be printed or deposited over the inks to protect the inks from removal from the upper and/or lower print layer. For example, a clear overlay layer can be provided on and over the upper print layer and/or the lower print layer. This clear overlay layer can be provided on and over the print layer with heat and pressure or with an adhesive between the clear overlay layer and the print layer.

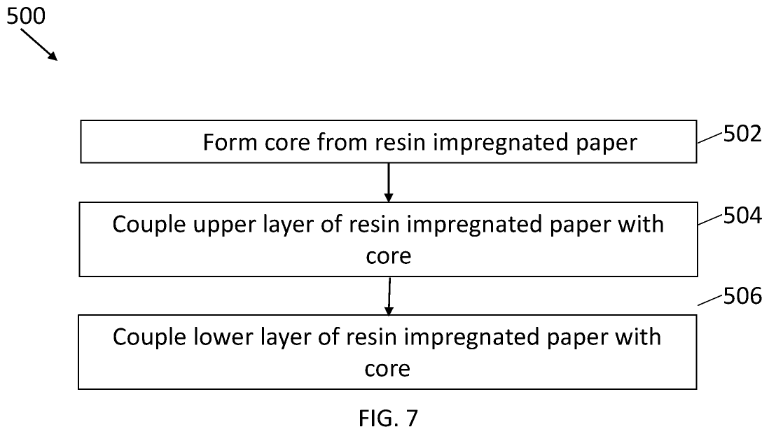

FIG. 7 illustrates a flowchart of a method 500 for forming a sheet assembly that can be cut into smaller cards according to one embodiment. The method 500 can represent the operations performed to create the sheet assembly 100 that is cut into the cards 102, 202, 302. At 502, a core is formed from paper impregnated with resin. The resin may be a biobased resin. A biobased resin may be a resin formed from renewable or biological resources. A biobased resin may be a resin that is not petroleum-based. Optionally, the paper and/or the resin may include high density particles that may be inorganic particles. The inorganic particles may include one or more of bismuth vanadate, one or more metal oxide pigments, or one or more conductive particles (e.g., copper particles, bronze particles, etc.). The core may also be provided with an inlay, such as an RFID antenna. The core may also comprise one or more layers of paper impregnated with resin.

At 504, an upper layer is coupled to the core. The upper layer may be a paper impregnated with resin. The rein may include a biobased resin. The resin may also include a petroleum-based resin. The upper layer may be coupled to the core by heat and pressure. The resin in the upper layer and the core may react to heat and pressure to self-glue the layers together. The upper layer may be formed of PET, a biobased polycarbonate film, or a pre-impregnated print base paper. The upper layer can receive a first printing of first indicia for one or more cards, as described above. For example, the inks may be printed on the upper sheet by the card manufacturer or producer. The upper layer may also be provided with a reflective feature, a diffractive feature, security and/or an opaque feature of the card.

At 506, a lower layer is coupled to the core to form a sheet assembly of the upper layer, the core, and the lower layer. The lower layer can be coupled with the core with the core disposed between the upper layer and the lower layer. The lower layer may be formed of the same material as the upper layer and like the upper layer, the lower layer can receive a second printing of second indicia for the one or more cards. The lower layer may also be provided with a reflective feature, a diffractive feature, security and/or an opaque feature of the card.

The sheet assembly may be provided with an upper clear overlay layer and a lower overlay clear layer to form a card(s) that may be cut out of the sheet assembly. The clear overlay layers may be a polymer or a paper impregnated with a resin. The resin may be a petroleum-based resin or a non-biodegradable resin. The clear upper and lower clear overlay layers may be coupled to the respective upper layer and lower layer by heat and pressure, or by adhesive.

In one embodiment, a sheet assembly is provided that can be cut into one or more cards. The sheet assembly includes an upper layer configured to receive a first printing of first indicia for the one or more cards. The sheet assembly may also include a core coupled with the upper layer and a lower layer configured to receive a second printing of second indicia for the one or more cards. The lower layer may be coupled with the core with the core disposed between the upper sheet and the lower sheet. One or more of the upper layer, the core, or the lower layer may be formed from paper impregnated with a resin that includes a biobased resin.

The resin may further include a petroleum-based resin.

The resin may be 40% to 70% biobased resin.

One or more of the paper or the resin of the one or more upper layer, the core, or the lower layer may include inorganic particles. The inorganic particles may include one or more of bismuth vanadate, one or more metal oxide pigments, or one or more conductive particles. The inorganic particles may include one or more conductive particles, which include one or more of copper particles or bronze particles.

The upper layer, the core, and the lower layer may continuously extend from a first edge of the sheet assembly to an opposite second edge of the sheet assembly, and the upper layer, the core, and the lower layer may continuously extend from a third edge of the sheet assembly to an opposite fourth edge of the sheet assembly with each of the third edge and the fourth edge continuously extending from the first edge to the second edge. The sheet assembly may not conduct electric current from any of the first edge, the second edge, the third edge, or the fourth edge to any of the first edge, the second edge, the third edge, or the fourth edge.

The core may include a radio frequency identification antenna.

The core may be formed from at least an upper core layer, a middle core layer, and a lower core layer with the upper core layer located between the middle core layer and the upper layer and the lower core layer located between the middle core layer and the lower layer.

One or both of the upper core layer or the lower core layer may include one or more of a reflective feature, a diffractive feature, or a holographic feature.

The sheet assembly may further include an inlay disposed on the middle core layer between the upper core layer and the lower core layer, the inlay including a radio frequency identification antenna.

The sheet assembly further includes an upper biobased film and a lower biobased film. The upper biobased film and the lower biobased films may be biobased polycarbonate films. One or more of the upper biobased film and the lower biobased film may include one or more of a metallized, holographic, diffractive, refractive, color shifting, or security feature.

The sheet assembly may not conduct electric current.

A card may be formed from the sheet assembly. The card may be one or more of a financial transaction card, an identity card, an access card, a key card, or a security card.

A laminate may be made from the sheet assembly. The laminate may form one or more of a countertop, a tabletop, a furniture covering, or flooring.

In one embodiment, a method for producing a sheet assembly may include forming a core and coupling an upper layer to the core, the upper layer configured to receive a first printing of first indicia for one or more cards. The method may include coupling a lower layer to the core to form a sheet assembly of the upper layer, the core, and the lower layer. The lower layer may be coupled with the core with the core disposed between the upper layer and the lower layer. The lower layer may be configured to receive a second printing of second indicia for the one or more cards. The sheet assembly may be configured to be cut into one or more cards. One or more of the upper layer, the core, or the lower layer may be formed from paper impregnated with a resin that includes a biobased resin.

The resin may further include a petroleum-based resin.

The resin may be 40% to 70% biobased resin.

One or more of the paper or the resin of the one or more upper layer, the core, or the lower layer may include inorganic particles. The inorganic particles may include one or more of bismuth vanadate, one or more metal oxide pigments, or one or more conductive particles. The inorganic particles may include one or more conductive particles, which include one or more of copper particles or bronze particles.

The upper layer, the core, and the lower layer may continuously extend from a first edge of the sheet assembly to an opposite second edge of the sheet assembly, and the upper layer, the core, and the lower layer may continuously extend from a third edge of the sheet assembly to an opposite fourth edge of the sheet assembly with each of the third edge and the fourth edge continuously extending from the first edge to the second edge. The sheet assembly may not conduct electric current from any of the first edge, the second edge, the third edge, or the fourth edge to any of the first edge, the second edge, the third edge, or the fourth edge.

The method may include placing a radio frequency identification antenna in the core.

Forming the core may include forming at least an upper core layer and a lower core layer with the upper core layer located between the lower core layer and the upper layer and the bottom core layer located between the upper core layer and the lower layer. One or both of the upper core layer or the lower core layer may include one or more of a reflective feature, a diffractive feature, or a holographic feature.

Forming the core may include forming an upper core layer, a lower core layer, and an inlay disposed between the upper core layer and the lower core layer. The inlay may include a radio frequency identification antenna.

The method may include providing an upper biobased film and a lower biobased film. The upper biobased film and the lower biobased films may be biobased polycarbonate films. One or more of the upper biobased film and the lower biobased film may include one or more of a metallized, holographic, diffractive, refractive, color shifting, or security feature.

The sheet assembly may not conduct electric current.

The method may include cutting the sheet assembly to form a card. The card may be one or more of a financial transaction card, an identity card, an access card, a key card, or a security card.

The method may include forming a laminate from the sheet assembly. The laminate may be one or more of a countertop, a tabletop, a furniture covering, or flooring.

In one embodiment, a sheet assembly is provided that can be cut into one or more cards. The sheet assembly may include an upper layer configured to receive a first printing of first indicia for the one or more cards and a core coupled with the upper sheet. The sheet assembly may include a lower layer configured to receive a second printing of second indicia for the one or more cards. The lower layer may be coupled with the core with the core disposed between the upper layer and the lower layer. The sheet assembly may include an upper clear overlay layer provided over the upper layer and a lower clear overlay layer provided over the lower layer. One or more of the upper layer, the core, or the lower layer may be formed from a paper impregnated with a resin that includes a biobased resin and the upper clear overlay layer and the lower clear overlay layer are formed of a polymer or a paper impregnated with a resin that includes a biobased resin.

The resin may also include a petroleum-based resin.

The resin may be 40% to 70% biobased resin.

One or more of the paper or the resin of the one or more upper layer, the core, or the lower layer may include inorganic particles. The inorganic particles may include one or more of bismuth vanadate, one or more metal oxide pigments, or one or more conductive particles which may include one or more of copper particles or bronze particles.

The upper layer, the core, and the lower layer may continuously extend from a first edge of the sheet assembly to an opposite second edge of the sheet assembly, and the upper layer, the core, and the lower layer may continuously extend from a third edge of the sheet to an opposite fourth edge of the sheet with each of the third edge and the fourth edge continuously extending from the first edge to the second edge. The sheet assembly may not conduct electric current from any of the first edge, the second edge, the third edge, or the fourth edge to any of the first edge, the second edge, the third edge, or the fourth edge.

The core may include a radio frequency identification antenna.

The core may be formed from at least an upper core layer and a lower core layer with the upper core layer located between the lower core layer and the upper layer and the lower core layer located between the upper core layer and the lower layer. One or both of the upper core layer or the lower core layer may include one or more of a reflective feature, a diffractive feature, or a holographic feature.

The sheet assembly may include an inlay disposed between the upper core layer and the lower core layer. The inlay may include a radio frequency identification antenna.

The upper layer may include an upper biobased film and the lower layer may include a lower biobased film. The upper biobased film and/or the lower biobased films may biobased polycarbonate films.

One or more of the upper biobased film or the lower biobased film comprise one or more of a metallized, holographic, diffractive, refractive, color shifting, or security feature.

The sheet assembly may not conduct electric current.

The method may include cutting the sheet assembly to form a card. The card may be one or more of a financial transaction card, an identity card, an access card, a key card, or a security card.

The method may include forming a laminate from the sheet assembly. The laminate may be one or more of a countertop, a tabletop, a furniture covering, or flooring.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A sheet assembly configured to be cut into one or more cards, the sheet assembly comprising:
an upper layer configured to receive a first printing of first indicia for the one or more cards;
a core coupled with the upper layer; and
a lower layer configured to receive a second printing of second indicia for the one or more cards, the lower layer coupled with the core with the core disposed between the upper layer and the lower layer,
wherein one or more of the upper layer, the core, or the lower layer is formed from paper impregnated with a resin that comprises a biobased resin.

2. The sheet assembly of claim 1, wherein the resin further comprises a petroleum-based resin.

3. The sheet assembly of claim 1, wherein the resin is 40% to 70% biobased resin.

4. The sheet assembly of claim 1, wherein one or more of the paper or the resin of the one or more of the upper layer, the core, or the lower layer includes inorganic particles including one or more of bismuth vanadate, one or more metal oxide pigments, or one or more conductive particles including one or more of copper particles or bronze particles.

5. The sheet assembly of claim 1, wherein the upper layer, the core, and the lower layer continuously extend from a first edge of the sheet assembly to an opposite second edge of the sheet assembly, and the upper layer, the core, and the lower layer continuously extend from a third edge of the sheet assembly to an opposite fourth edge of the sheet assembly with each of the third edge and the fourth edge continuously extending from the first edge to the second edge,
wherein the sheet assembly does not conduct electric current from any of the first edge, the second edge, the third edge, or the fourth edge to any of the first edge, the second edge, the third edge, or the fourth edge.

6. The sheet assembly of claim 1, wherein the core is formed from at least an upper core layer, a middle core layer, and a lower core layer with the upper core layer located between the middle core layer and the upper layer and the lower core layer located between the middle core layer and the lower layer, and one or both of the upper core layer or the lower core layer includes one or more of a reflective feature, a diffractive feature, or a holographic feature.

7. The sheet assembly of claim 6, further comprising an inlay disposed on the middle core layer between the upper core layer and the lower core layer, the inlay including a radio frequency identification antenna.

8. The sheet assembly of claim 1, further comprising an upper biobased film and a lower biobased film, and one or more of the upper biobased film and the lower biobased film comprise one or more of a metallized, holographic, diffractive, refractive, color shifting, or security feature.

9. The sheet assembly of claim 1, further comprising:
an upper clear overlay layer provided over the upper layer; and
a lower clear overlay layer provided over the lower layer, wherein one or more of the upper clear overlay layer or the lower clear overlay layer are formed of a biobased polymer or a paper impregnated with a resin that comprises a biobased resin.

10. A card made from the sheet assembly of claim 1, wherein the card is one or more of a financial transaction card, an identity card, an access card, a key card, or a security card.

11. A laminate comprising the sheet assembly of claim 1, wherein the laminate is included in forms one or more of a countertop, a tabletop, a furniture covering, or flooring.

12. A method comprising:
forming a core;
coupling an upper layer to the core, the upper layer configured to receive a first printing of first indicia for one or more cards; and
coupling a lower layer to the core to form a sheet assembly of the upper layer, the core, and the lower layer, the lower layer coupled with the core with the core disposed between the upper layer and the lower layer, the lower layer configured to receive a second printing of second indicia for the one or more cards,
one or more of the upper layer, the core, or the lower layer is formed from paper impregnated with a resin that comprises a biobased resin.

13. The method of claim 12, wherein the resin further comprises a petroleum-based resin.

14. The method of claim 12, wherein the resin is 40% to 70% biobased resin.

15. The method of claim 12, wherein one or more of the paper or the resin of the one or more of the upper layer, the core, or the lower layer includes inorganic particles including one or more of bismuth vanadate, one or more metal oxide pigments, or one or more conductive particles including one or more of copper particles or bronze particles.

16. The method of claim 12, wherein the upper layer, the core, and the lower layer continuously extend from a first edge of the sheet assembly to an opposite second edge of the sheet assembly, and the upper layer, the core, and the lower layer continuously extend from a third edge of the sheet assembly to an opposite fourth edge of the sheet assembly with each of the third edge and the fourth edge continuously extending from the first edge to the second edge,
wherein the sheet assembly does not conduct electric current from any of the first edge, the second edge, the third edge, or the fourth edge to any of the first edge, the second edge, the third edge, or the fourth edge.

17. The method of claim 12, wherein forming the core includes forming at least an upper core layer and a lower core layer with the upper core layer located between the lower core layer and the upper layer and the lower core layer located between the upper core layer and the lower layer, wherein one or both of the upper core layer or the lower core layer includes one or more of a reflective feature, a diffractive feature, or a holographic feature.

18. The method of claim 17, wherein forming the core includes forming an upper core layer, a lower core layer, and an inlay disposed between the upper core layer and the lower core layer, the inlay including a radio frequency identification antenna.

19. The method of claim 18, further comprising providing an upper biobased film between the upper layer and the core and providing a lower biobased film between the core and the lower layer, wherein the upper biobased film and the lower biobased films are biobased polycarbonate films, and one or more of the upper biobased film and the lower biobased film comprise one or more of a metallized, holographic, diffractive, refractive, color shifting, or security feature.

20-22. (canceled)

23. A method comprising:
forming a core;
coupling an upper layer to the core, the upper layer configured to receive a first printing of first indicia;
coupling a lower layer to the core to form a sheet assembly of the upper layer, the core, and the lower layer, the lower layer coupled with the core with the core disposed between the upper layer and the lower layer, the lower layer configured to receive a second printing of second indicia, one or more of the upper layer, the core, or the lower layer is formed from paper impregnated with a resin that comprises a biobased resin;
providing an upper clear overlay layer over the upper layer;
providing a lower clear overlay layer over the lower layer, one or more of the upper clear overlay layer or the lower clear overlay layer are formed of a biobased polymer or a paper impregnated with a resin that comprises a biobased resin; and
forming a laminate from the sheet assembly, the laminate comprising one or more of a countertop, a tabletop, a furniture covering, or flooring.
